(19) United States
(12) Patent Application Publication
(10) Pub. No.: US 2020/0186478 A1
(43) Pub. Date: Jun. 11, 2020

(54) Dispatching Method and Edge Computing System

(71) Applicant: XRSpace CO., LTD., Taoyuan City (TW)

(72) Inventors: Peter Chou, Taipei City (TW); Feng-Seng Chu, New Taipei City (TW)

(21) Appl. No.: 16/215,440

(22) Filed: Dec. 10, 2018

(51) Int. Cl. H04L 12/913

(52) U.S. Cl. CPC H04L 47/724; H04L 67/10

(57) ABSTRACT

A task dispatching method, applied in an edge computing system comprising an edge computing device and a mobile device, is disclosed. The method comprises sending, by the mobile device, a resource inquiry message to the edge computing device through a connection, wherein the connection comprises a wireless connection, a one-way transmission latency of the connection is less than 10 milliseconds, and the resource inquiry message comprises an inquiry of which resource type the edge computing device is equipped with; sending, by the edge computing device, a resource response message corresponding to the resource inquiry message; and determining, by the mobile device, to dispatch the second type of computing task to the second computing device when the resource response message indicates that the edge computing device comprises the second computing device equipped with the second type of processor.

### BACKGROUND OF THE INVENTION

### 1. Field of the Invention

The present disclosure relates to a dispatching method and an edge computing system, and more particularly, to a dispatching method and an edge computing system capable of obtaining information of a resource type of an edge computing device and dispatching a task accordingly.

### 2. Description of the Prior Art

Edge computing attracts signification attention recently. Compared to cloud computing, edge computing devices are deployed by base stations, and in some situation, latency between the user and the edge computing device is much lower than latency between the user and the cloud computing device. Thus, the edge computing devices are suitable to perform tasks of real-time applications.

In some circumstance, some edge computing devices may be equipped with an additional processor, for example, a graphic processing units (GPU) or a tensor processing units (TPU). However, the mobile device may not have knowledge or information of what kind of processor is equipped with the edge computing device. For example, the mobile device may not know the edge computing device is equipped with the GPU. Thus, the mobile device may not hand the real-time task suitable to be executed by the GPU to the edge computing device, such that efficiency of the edge computing device is degraded.

### SUMMARY OF THE INVENTION

It is therefore an objective of the present disclosure to provide a dispatching method and an edge computing system capable of obtaining information of a resource type of an edge computing device and dispatching a computing task accordingly.

An embodiment of the present disclosure discloses a method of dispatching task. The method of dispatching task is applied in an edge computing system. The edge computing system comprises an edge computing device and a mobile device. The edge computing devices comprises a first computing device and/or a second computing device. The mobile device has a first type of computing task and a second type of computing task to be dispatched. The first computing device is equipped with a first type of processor but not equipped with a second type of processor, and the second computing device is equipped with both the first type of processor and the second type of processor. The method comprises sending, by the mobile device, a resource inquiry message to the edge computing device through a connection, wherein the connection comprises a wireless connection, a one-way transmission latency of the connection is less than 10 milliseconds, and the resource inquiry message comprises an inquiry of which resource type the edge computing device is equipped with; sending, by the edge computing device, a resource response message corresponding to the resource inquiry message, wherein the resource response message indicates whether the edge computing device comprises the second computing device equipped with the second type of processor; and determining, by the mobile device, to dispatch the second type of computing task to the second computing device when the resource response message indicates that the edge computing device comprises the second computing device equipped with the second type of resource; wherein the first type of processor is suitable to execute the first type of the computing task compared to the second type of processor, and the second type of processor is suitable to execute the second type of the computing task compared to the first type of processor .

An embodiment of the present disclosure further discloses an edge computing system. The edge computing system comprises a mobile device, having a first type of computing task and a second type of computing task to be dispatched, configured to send a resource inquiry message to the edge computing device through a connection, wherein the connection comprises a wireless connection, a one-way transmission latency of the connection is less than 10 milliseconds, and the resource inquiry message comprises an inquiry of which resource type the edge computing device is equipped with; and an edge computing device, comprising a first computing device and/or a second computing device, configured to send a resource response message corresponding to the resource inquiry message, wherein the resource response message indicates whether the edge computing device comprises the second computing device equipped with the second type of processor, the first computing device is equipped with a first type of processor but not equipped with a second type of processor, and the second computing device is equipped with both the first type of processor and the second type of processor; wherein the mobile device determines to dispatch the second type of task to the second computing device when the resource response message indicates that the edge computing device comprises the second computing device equipped with both the first type of processor and the second type of processor; wherein the first type of processor is suitable to execute the first type of the computing task compared to the second type of processor, and the second type of processor is suitable to execute the second type of the computing task compared to the first type of processor.

An embodiment of the present disclosure further discloses a mobile device, applied in an edge computing system. The edge computing system comprises an edge computing device. The edge computing devices comprises a first computing device and/or a second computing device. The first computing device is equipped with a first type of processor but not equipped with a second type of processor. The second computing device is equipped with both the first type of processor and the second type of processor. The mobile device sends a resource inquiry message to the edge computing device through a connection. The connection comprises a wireless connection. A one-way transmission latency of the connection is less than 10 milliseconds. The resource inquiry message comprises an inquiry of which resource type the edge computing device is equipped with. The edge computing device sends a resource response message corresponding to the resource inquiry message. The resource response message indicates whether the edge computing device comprises the second computing device equipped with the second type of processor. The mobile device determines to dispatch the second type of computing task to the second computing device when the resource response message indicates that the edge computing device comprises the second computing device equipped with the second type of processor. The first type of processor is suitable to execute the first type of the computing task compared to the second type of processor, and the second type of processor is suitable to execute the second type of the computing task compared to the first type of processor.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an edge computing system according to an embodiment of the present disclosure.

FIG. 2 is a schematic diagram of a dispatching process according to an embodiment of the present disclosure.

FIG. 3 is a timing sequence of the dispatching process in FIG. 2.

### DETAILED DESCRIPTION

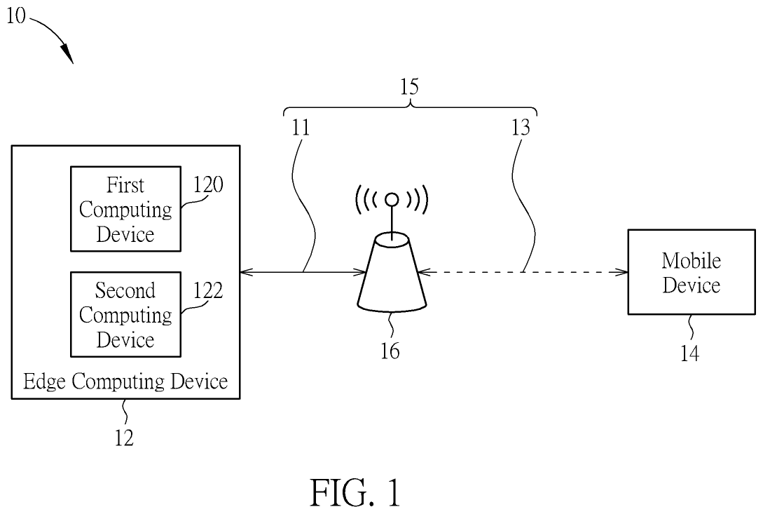

FIG. 1 is a schematic diagram of an edge computing system 10 according to an embodiment of the present disclosure. The edge computing system 10 comprises an edge computing device 12 and a mobile device 14. The mobile device 14 may be a phone, a tablet, a laptop, a virtual reality (VR) device, an augmented reality (AR) device, a mixed reality (MR) device, an extended reality (XR) device or a vehicular device (i.e., an electronic device disposed on a vehicle), but not limited thereto. The edge computing device 12 may be a computer cluster or a clustered computing system. The edge computing device 12 may comprise a first computing device 120, a second computing device 122 or both of the first computing device 120 and the second computing device 122. The first computing device 120 and/or the second computing device 122 may be a computer or a server, disposed by a station 16. The edge computing device 12 and the station 16 may be wireline connected, which means that a wireline connection 11 is between the edge computing device 12 and the station 16. The station 16 may be a macro base station (or an eNodeB (evolved Node B)), a femto base station or an access point (AP). The mobile device 14 is located within a service coverage/area of the station 16 and served by the station 16 in wireless communication perspective, which means that the mobile device 14 and the station 16 are communicated through an air interface or a wireless connection 13, where the wireless connection 13, which may be 5G wireless communication system for example, is required to have low latency. Specifically, given that a connection 15 between the edge computing device 12 and the mobile device 14 may comprise the wireline connection 11 and the wireless connection 13, a one-way transmission latency, i.e., a transmission latency from the mobile device 14 to the edge computing device 12 or a transmission latency from the edge computing device 12 to the mobile device 14, of the connection 15 is less than 10 milliseconds. Since the latency if the connection 15 is low, the edge computing device 12 is suitable for executing tasks of real-time applications.

In an embodiment, the first computing device 120 may be equipped with a first type of processor but not equipped with a second type of processor, the second computing device 122 may be equipped with both the first type of processor and the second type of processor. The first type of processor may be a central processing unit (CPU) and the second type of processor may be a graphics processing unit (GPU) or a tensor processing unit (TPU).

In this regard, the mobile device 14 always can dispatch a first type of computing task, which is a real-time application, to the edge computing device 12 and have the edge computing device 12 execute the first type of computing task using the CPU of the edge computing device 12, where the first type of computing task is suitable to be executed by a general purpose CPU. For example, for an autonomous vehicle application/scenario, the mobile device 14 may be disposed within an autonomous vehicle, and the first type of computing task may be a collision detection operation, based on images captured by camera disposed on the autonomous vehicle, since the collision detection operation is suitable to be executed by the general purpose CPU.

On the other hand, if the mobile device 14 has knowledge/information about the edge computing device 12 which comprises the second computing device 122 equipped with the GPU, the mobile device 14 may hand a second type of computing task, which is also a real-time application, to the edge computing device 12 (especially to the second computing device 122) and have the edge computing device 12 (or the second computing device 122) execute the second type of computing task using the GPU within the edge computing device 12, where the second type of computing task is suitable to be executed by the GPU. For example, for a VR application/scenario, the mobile device 14 may be a reality presenting device (e.g., a VR device), and the second type of computing task is a VR rendering operation, which is suitable to be executed by the GPU. Thus, a computation burden of the mobile device 14, especially the burden corresponding to the second type of computing task, can be shared by the edge computing device 12, and power consumption of the mobile device 14 can be reduced, if the mobile device 14 knows that the edge computing device 12 is equipped with the GPU.

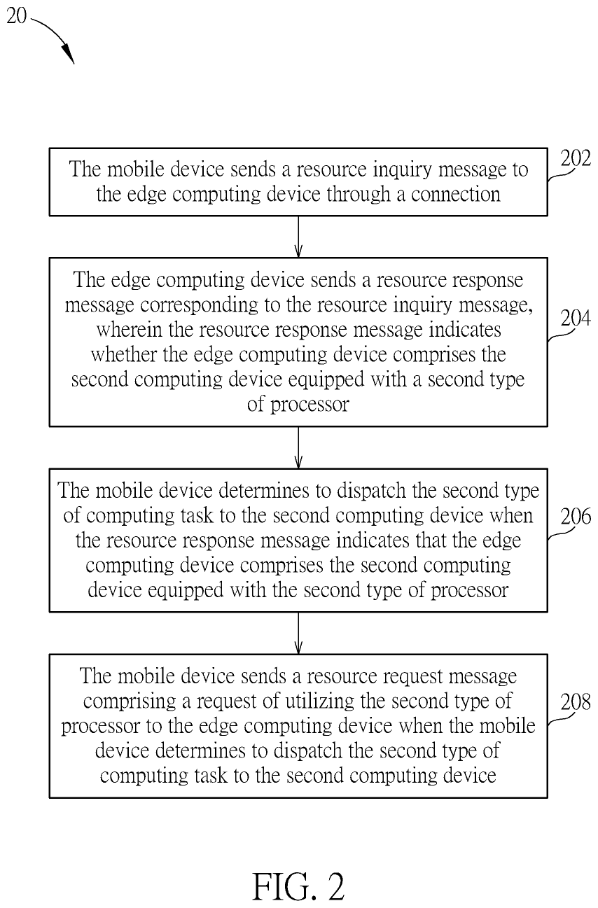

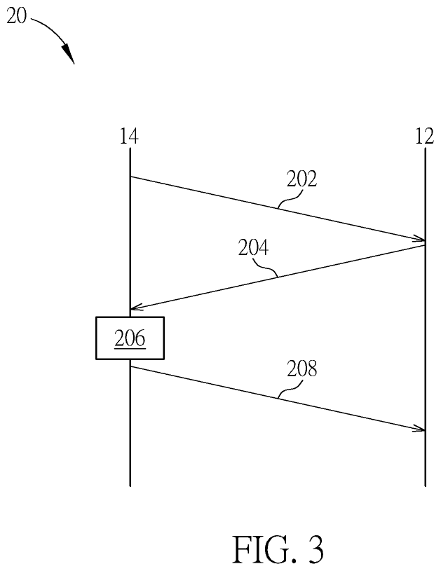

FIG. 2 is a schematic diagram of a dispatching process 20 according to an embodiment of the present disclosure. FIG. 3 is a timing sequence of the dispatching process 20. The dispatching process 20 is a protocol mainly for the mobile device 14 to have knowledge about whether the edge computing device 12 is equipped with the GPU. The dispatching process 20 comprises the following steps:

Step 202: The mobile device sends a resource inquiry message to the edge computing device through a connection.

Step 204: The edge computing device sends a resource response message corresponding to the resource inquiry message, wherein the resource response message indicates whether the edge computing device comprises the second computing device equipped with a second type of processor.

Step 206: The mobile device determines to dispatch the second type of computing task to the second computing device when the resource response message indicates that the edge computing device comprises the second computing device equipped with the second type of processor.

Step 208: The mobile device sends a resource request message comprising a request of utilizing the second type of processor to the edge computing device when the mobile device determines to dispatch the second type of computing task to the second computing device.

In Step 202, the mobile device 14 may send a resource inquiry message RI to the edge computing device 12 through the connection 15. The resource inquiry message RI comprises an inquiry message of resource type with information of what kind of hardware resource the edge computing device 12 is equipped with. The resource inquiry message RI comprises an inquiry message of whether the edge computing device 12 comprises the second computing device 122 equipped with the second type of processor. The format of the resource inquiry message RI and/or the inquiry message are not limited.

After the resource inquiry message RI is received by the edge computing device 12, in Step 204, the edge computing device 12 responses and sends a resource response message RR corresponding to the resource inquiry message RI. The resource response message RR may indicate that the edge computing device 12 comprises the first computing device 120 only equipped with a first type of processor (e.g., the CPU), or the resource response message RR may indicate that the edge computing device 12 comprises the second computing device 122 equipped with a first type of processor equipped with both the first type of processor and the second type of processor (e.g., the GPU). In other words, the resource response message RR indicates whether the edge computing device 12 comprises the second computing device 122 which is equipped with the second type of processor.

After the resource response message RR is received by the mobile device 14, the mobile device 14 determines to dispatch the second type of computing task to the second computing device 122 according to the resource response message, where the first type of computing task is suitable to be executed by the first type of processor and the second type of computing task is suitable to be executed by the second type of processor. The second type of computing task being suitable to be executed by the second type of processor means that the edge computing device 12 would gain better performance (e.g., more efficiency or consuming less power) when the second type of computing task is executed by the second type of processor, rather than the first type of processor. It means that the second type of processor may be specifically designed for performing the second type of computing task. For example, GPU is specifically designed for performing graphic-related operation, and the VR rendering operation is one kind of the graphic-related operation. Thus, the VR rendering operation is suitable to be executed by the GPU. In other words, the first type of processor is much suitable to execute the first type of the computing task compared to the second type of processor, and the second type of processor is much suitable to execute the second type of the computing task compared to the first type of processor.

When the resource response message RR indicates that the edge computing device 12 comprises the second computing device 122 which is equipped with the second type of processor (e.g., GPU), in Step 206, the mobile device 14 determines to dispatch the second type of computing task (e.g., VR rendering operation for the VR devices) to the edge computing device 12, or specifically, the second computing device 122.

Once the mobile device 14 determines to dispatch the second type of computing task (e.g., VR rendering operation) to the edge computing device 12, in Step 208, the mobile device 14 sends a resource request message RSR to the edge computing device 12, where the resource request message RSR comprises a request of utilizing the second type of processor (e.g., GPU). When the edge computing device 12 receives the mobile device 14, the edge computing device 12 may review its second type of processor to see if the second type of processor thereof are still available (for executing the second type of computing task), and sends an acknowledgement message ACK_R corresponding to the resource request message RSR back to the mobile device 14.

After the mobile device 14 receives the acknowledgement message ACK_R, the mobile device 14 may send a second parameter corresponding to the second type of computing task to the edge computing device 12. For example, suppose that the second type of computing task is the VR rendering operation, the second parameter may be a screen size or a resolution of a screen of the mobile device 14.

After the second parameter is received by the edge computing device 12, the edge computing device 12 are ready to execute the second type of computing task.

In an embodiment, the mobile device 14 may also dispatch the first type of computing task to the first computing device 120 within the edge computing device 12. Details of sending request of utilizing the first type of processor and sending a first parameter corresponding to the first type of computing task is similar to which of the second type of processor and the first type of computing task, which is not narrated herein for brevity.

In the prior art, the mobile device does not have knowledge of what kind of processor is equipped within the edge computing device. In comparison, the mobile device of the present disclosure is able to obtain the resource type of the edge computing device. Thereby, the mobile device of the present disclosure may hand a specific type of computing task which is suitable to be executed by a specific resource, such that a computation burden of the mobile device corresponding to the specific type of computing task can be shared by the edge computing device, and the power consumption of the mobile device can be reduce.

In summary, the mobile device of the present disclosure is able to obtain the resource type of the edge computing device and hand the specific type of computing task, being a real-time application, which is suitable to be executed by the specific resource, such that the computation burden of the mobile device corresponding to the specific type of computing task can be shared by the edge computing device, and the power consumption of the mobile device can be reduce.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of dispatching task, applied in an edge computing system comprising an edge computing device and a mobile device, the edge computing devices comprising a first computing device, a second computing device or both the first computing device and the second computing device, the mobile device having a first type of computing task and a second type of computing task to be dispatched, wherein the first computing device is equipped with a first type of processor but not equipped with a second type of processor, the second computing device is equipped with both the first type of processor and the second type of processor, the method comprising:
sending, by the mobile device, a resource inquiry message to the edge computing device through a connection, wherein the connection comprises a wireless connection, a one-way transmission latency of the connection is less than 10 milliseconds, and the resource inquiry message comprises an inquiry of which resource type the edge computing device is equipped with;
sending, by the edge computing device, a resource response message corresponding to the resource inquiry message, wherein the resource response message indicates whether the edge computing device comprises the second computing device equipped with the second type of processor; and
determining, by the mobile device, to dispatch the second type of computing task to the second computing device when the resource response message indicates that the edge computing device comprises the second computing device equipped with the second type of processor;
wherein the first type of processor is suitable to execute the first type of the computing task compared to the second type of processor, and the second type of processor is suitable to execute the second type of the computing task compared to the first type of processor.

2. The method of claim 1, wherein the first type of processor is a central processing unit (CPU) and the second type of processor is a graphics processing unit (GPU) or a tensor processing unit (TPU).

3. The method of claim 1, wherein the first type of computing task and the second type of computing task are both real-time applications.

4. The method of claim 1, further comprising:
dispatching the first type of computing task to the first computing device when the resource response message indicates that the edge computing device comprises the first computing device equipped with the first type of processor.

5. The method of claim 1, further comprising:
sending, by the mobile device, a resource request message comprising a request of utilizing the second type of processor to the second computing device when the mobile device determines to dispatch the second type of computing task to the second computing device.

6. The method of claim 1, further comprising:
sending, by the mobile device, a parameter corresponding to the second type of computing task to the second computing device when the mobile device determines to dispatch the second type of task to the second computing device.

7. An edge computing system, comprising:
a mobile device, having a first type of computing task and a second type of computing task to be dispatched, configured to send a resource inquiry message to the edge computing device through a connection, wherein the connection comprises a wireless connection, a one-way transmission latency of the connection is less than 10 milliseconds, and the resource inquiry message comprises an inquiry of which resource type the edge computing device is equipped with; and
an edge computing device, comprising a first computing device, a second computing device or both the first computing device and the second computing device, configured to send a resource response message corresponding to the resource inquiry message, wherein the resource response message indicates whether the edge computing device comprises the second computing device equipped with the second type of processor, the first computing device is equipped with a first type of processor but not equipped with a second type of processor, and the second computing device is equipped with both the first type of processor and the second type of processor;
wherein the mobile device determines to dispatch the second type of task to the second computing device when the resource response message indicates that the edge computing device comprises the second computing device equipped with both the first type of processor and the second type of processor;
wherein the first type of processor is suitable to execute the first type of the computing task compared to the second type of processor, and the second type of processor is suitable to execute the second type of the computing task compared to the first type of processor.

8. The edge computing system of claim 7, wherein the first type of processor is a central processing unit (CPU) and the second type of processor is a graphics processing unit (GPU) or a tensor processing unit (TPU).

9. The edge computing system of claim 7, wherein the first type of computing task and the second type of computing task are both real-time applications.

10. The edge computing system of claim 7, wherein the mobile device dispatches the first type of computing task to the first computing device when the resource response message indicates that the edge computing device comprises the first computing device equipped with the first type of processor.

11. The edge computing system of claim 7, wherein the mobile device sends a resource request message comprising a request of utilizing the second type of processor to the second computing device when the mobile device determines to dispatch the second type of computing task to the second computing device.

12. The edge computing system of claim 7, wherein the mobile device sends a parameter corresponding to the second type of computing task to the second computing device when the mobile device determines to dispatch the second type of task to the second computing device.

13. A mobile device, applied in an edge computing system,
wherein the edge computing system comprises an edge computing device, the edge computing devices comprises a first computing device, a second computing device or both the first computing device and the second computing device, the first computing device is equipped with a first type of processor but not equipped with a second type of processor, the second computing device is equipped with both the first type of processor and the second type of processor;
wherein the mobile device sends a resource inquiry message to the edge computing device through a connection, the connection comprises a wireless connection, a one-way transmission latency of the connection is less than 10 milliseconds, and the resource inquiry message comprises an inquiry of which resource type the edge computing device is equipped with;
wherein the edge computing device sends a resource response message corresponding to the resource inquiry message, wherein the resource response message indicates whether the edge computing device comprises the second computing device equipped with the second type of processor;
wherein the mobile device determines to dispatch the second type of computing task to the second computing device when the resource response message indicates that the edge computing device comprises the second computing device equipped with the second type of processor;
wherein the first type of processor is suitable to execute the first type of the computing task compared to the second type of processor, and the second type of processor is suitable to execute the second type of the computing task compared to the first type of processor.

14. The mobile device of claim 13, wherein the first type of processor is a central processing unit (CPU) and the second type of processor is a graphics processing unit (GPU) or a tensor processing unit (TPU).

15. The mobile device of claim 13, wherein the first type of computing task and the second type of computing task are both real-time applications.

16. The mobile device of claim 13, wherein the mobile device dispatches the first type of computing task to the first computing device when the resource response message indicates that the edge computing device comprises the first computing device equipped with the first type of processor.

17. The mobile device of claim 13, wherein the mobile device sends a resource request message comprising a request of utilizing the second type of processor to the second computing device when the mobile device determines to dispatch the second type of computing task to the second computing device.

18. The mobile device of claim 13, wherein the mobile device sends a parameter corresponding to the second type of computing task to the second computing device when the mobile device determines to dispatch the second type of task to the second computing device.
